(19) United States
(12) Patent Application Publication
(10) Pub. No.: US 2012/0056710 A1
(43) Pub. Date: Mar. 8, 2012

(54) DATA TRANSMISSION METHOD, PIPELINE MONITORING METHOD, RF TRANSCEIVER AND SYSTEM

(76) Inventor: LIPING ZHU, SAN JOSE, CA (US)

(21) Appl. No.: 13/225,514

(22) Filed: Sep. 5, 2011

Related U.S. Application Data
(60) Provisional application No. 61/380,314, filed on Sep. 6, 2010.

(30) Foreign Application Priority Data
Nov. 29, 2010 (CN) 201010571914.5

(51) Int. Cl. G05B 23/02; H04B 1/38

(52) U.S. Cl. 340/3.1; 455/73

(57) ABSTRACT

The present invention discloses a data transmission method, pipeline monitoring method, RF transceiver and system. The method comprises: broadcasting and transmitting, by a first radio frequency (RF) transceiver, a data transmission request, and receiving, by the first RF transceiver, a data transmission response returned by a second RF transceiver, wherein the data transmission response includes at least a local identification (ID) of the second RF transceiver as an object ID; analyzing and obtaining, by the first RF transceiver, the object ID from the data transmission response; judging, by the first RF transceiver, whether the second RF transceiver returning the data transmission response is a data receiver according to the local ID and the object ID, if so, sending data to the second RF transceiver; and repeatedly performing, by the second RF transceiver, the above operations of the first RF transceiver, until the local RF transceiver is determined to be the data receiver according to the local ID, and then the data transmission stops. The present invention solves the problem of RF transmission distance limit with the RF devices in a way of point-to-point and directional transmission, thereby realizing the long-distance data transmission at a low cost.

### CROSS-REFERENCE TO RELATED APPLICATIONS

This application claims priorities to U.S. Provisional Application No. 61/380,314 filed on Sep. 6, 2010, and Chinese Patent Application No. 201010571914.5 filed on Nov. 29, 2010, which are hereby incorporated by reference in their entirety.

### FIELD OF THE TECHNOLOGY

The embodiments of the present invention relate to wireless communication technology, particularly a data transmission method, a pipeline monitoring method, a radio frequency (RF) transceiver and system.

### BACKGROUND

Currently, the long-distance pipeline transfer is the primary means to transfer fuel gas, gasoline and other substances. Take the gasoline transfer for example, it requires an extremely complex and enormous transfer pipeline network to transfer gasoline trans-provincially, or even trans-continentally, and it transfers the gasoline to the users and enterprises at the terminal in a way of level-by-level distribution. In such transfer pipeline network, the transfer pipelines can be mainly divided into three categories. The first category can be called as collection pipeline, which is a complex pipeline group consisting of relatively shorter interactive pipelines, for transferring crude oil or air supply from the nearby oil well to the processing plant or treatment plant. The second category can be called as transportation pipeline, which mainly refers to the relatively longer pipeline having large diameter, for transferring fluid products such as gasoline, natural gas and smelting products among different cities, countries and even continents. The transportation pipeline is applicable to long-distance, high-flow and uninterrupted transfer, and multiple pressure stations or pumping stations and so on are usually arranged in the transportation pipeline network to ensure the transportation of the fluid products. The third category can be called as distribution pipeline, which is made up of a multitude of interactively connected pipelines that have small diameters, for delivering products to the users at the terminal. The distribution pipeline which has numerous branches can deliver natural gas or gasoline and so on to households or downstream enterprises.

Whether such enormous transfer pipeline network can accomplish the transportation continuously or not is quite important for the industrial production, even for the economic health and national security. This requires the transfer pipeline network capable of monitoring the operation condition of the transfer pipeline. The monitoring scheme in the existing technology is illustrated in FIG. 1, wherein the field instruments are arranged at the remote terminal units (RTUs) in the transfer pipeline network respectively for collecting the information of the pipeline in real time. The field instruments can include flow meter, pressure meter, temperature meter, transponder and other sensor devices. The information collected by these field instruments is firstly assembled in the local RTU, and the RTU then sends the field data to the master control room at the center position in real time by using the communication system. The used communication system can utilize satellite channels, microwave links or cellular circuit connection and so on.

However, the monitoring technology level for pipeline is limited by the capability of the communication system. If the communication technologies such as satellite, cellular network and so on are employed in RTU, a tremendous economic cost of equipments and also a relatively greater power support are required in the large-range and long-distance communication, so that usually RTU can transmit only a small amount of basic information. Furthermore, owing to the higher cost, these pieces of equipment can not be used widely and usually can only be arranged in some particular locations, for instance, fueling station, distribution station, pumping station, pressure station, stop valve station and so forth, as illustrated in FIG. 1, so that a whole process monitoring of the transfer pipeline can not be achieved. Moreover, because the transfer pipeline is usually arranged in the remote field, the cost of dispatching the ground crew regularly to monitor and maintain is extremely high. Therefore, presently, most of the transfer pipeline can not be effectively monitored and all the regions out of monitoring have the potential safety risks such as breakage and pilferage.

In order to improve the monitoring level of the long-distance transfer pipeline, the high cost problem of the long-distance data transmission needs to be solved in priority for the existing technology.

### SUMMARY

The present invention provides a data transmission method, a pipeline monitoring method, an RF transceiver and system to realize long-distance data transmission at a low cost.

The embodiments of the present invention provide a data transmission method, comprising:

broadcasting and transmitting, by a first radio frequency (RF) transceiver, a data transmission request, and receiving, by the first RF transceiver, a data transmission response returned by a second RF transceiver, wherein the data transmission response includes at least a local identification (ID) of the second RF transceiver as an object ID;

analyzing and obtaining, by the first RF transceiver, the object ID from the data transmission response;

judging, by the first RF transceiver, whether the second RF transceiver returning the data transmission response is a data receiver according to the local ID and the object ID, if so, sending data to the second RF transceiver; and

repeatedly performing, by the second RF transceiver, the above operations of the first RF transceiver, until a local RF transceiver is determined to be the data receiver according to the local ID, and then the data transmission stops.

The embodiments of the present invention also provide a pipeline monitoring method, comprising:

collecting, by each of RF transceivers, data from an RFID tag of each of sensors arranged at intervals along the pipeline;

sending, by each of the RF transceivers as a first RF transceiver, the data to a data receiver through the data transmission method provided by any embodiment of the present invention; and

sending, by the data receiver, the data to a master control room to monitor a status of the pipeline according to the data.

The embodiments of the present invention further provide an RF transceiver, comprising:

a transmission request module, adapted to broadcast and transmit a data transmission request;

a response receiving module, adapted to receive a data transmission response returned by a second RF transceiver, wherein the data transmission response includes at least a local ID of the second RF transceiver as an object ID;

an ID acquisition module, adapted to analyze and obtain the object ID from the data transmission response;

an object judgment module, adapted to judge whether the second RF transceiver returning the data transmission response is a data receiver according to the local ID and the object ID; and

a data sending module, adapted to send data to the second RF transceiver when the second RF transceiver returning the data transmission response is determined to be the data receiver.

The embodiments of the present invention further provide a pipeline monitoring system, comprising:

multiple RFID tags, arranged at intervals along the pipeline and connected with sensors, for acquiring detection parameters of the sensors as data;

multiple RF transceivers provided by any embodiment of the present invention, arranged at intervals along the pipeline, for transmitting the data to the data receiver; and

the data receiver, adapted to send the data to a master control room when receiving the data sent by the RF transceivers, to monitor a status of the pipeline according to the data.

The data transmission method, pipeline monitoring method, RF transceiver and system provided by the present invention can take advantages of the RF device transmission at a low cost and wireless communication, and solve the problem of RF transmission distance limit through point-to-point and directional transmission, thereby realizing the long-distance data transmission at a low cost. The technical solution is particularly applicable for monitoring the long-distance pipeline, and it can fully monitor the operation status of the pipeline to improve the work reliability.

### BRIEF DESCRIPTION OF THE DRAWINGS

FIG. 1 is a structural diagram of a pipeline monitoring system in the prior art;

FIG. 2 is a flow chart of a data transmission method provided by the first embodiment of the present invention;

FIG. 3 is a flow chart of a pipeline monitoring method provided by the second embodiment of the present invention;

FIG. 4 is a structural diagram of an RF transceiver provided by the third embodiment of the present invention; and

FIG. 5 is a structural diagram of a pipeline monitoring system provided by the fifth embodiment of the present invention.

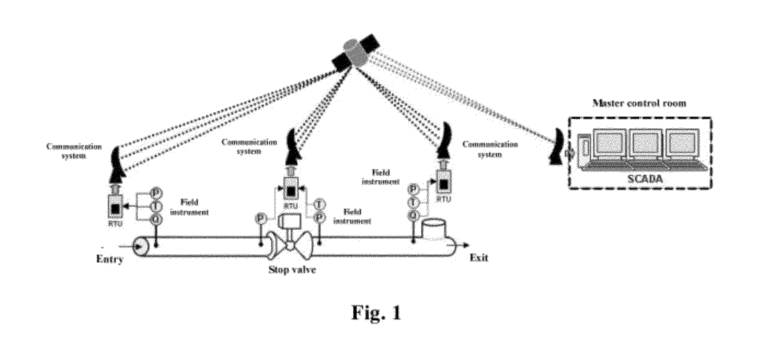

### DETAILED DESCRIPTION

To further clarify the purposes, technical solution and advantages of the embodiments of the present invention, the technical solutions in the embodiments of the present invention will be clearly and completely described in combination with the figures in the embodiments of the present invention in the following description. It is obvious that the described embodiments are only parts of the embodiments of the present invention, not all the embodiments. Based on the embodiments of the present invention, any other embodiments that can be obtained by one skilled in the art without any innovative work fall in the protection scope of the present invention.

### Embodiment 1

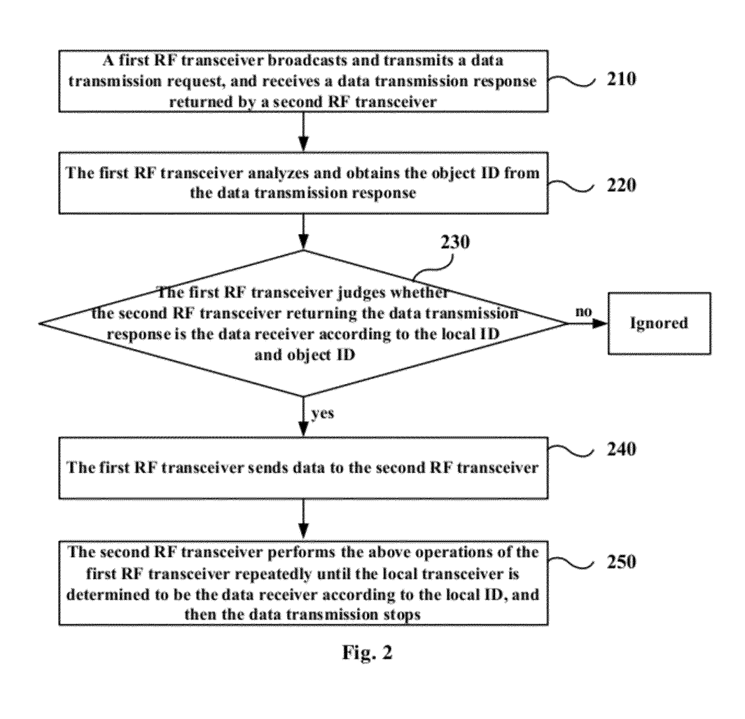

FIG. 2 is a flow chart of a data transmission method provided by the first embodiment of the present invention, which is applicable to a system including multiple RF transceivers. The system also includes a data receiver, which can also be an RF transceiver or other device that can receive data, acting as the object of data transmission in the system. The method of the present embodiment realizes the level-by-level data transmission to the data receiver through multiple RF transceivers. The method specifically includes the following steps:

Step 210: a first RF transceiver broadcasts and transmits a data transmission request, and receives a data transmission response returned by a second RF transceiver, wherein the data transmission response includes at least a local identification (ID) of the second RF transceiver as an object ID;

In said step 210, the first RF transceiver can be any RF transceiver which needs to transmit data to the data receiver in the system, and the operations performed by all the first RF transceivers which need to transmit data are the same. The second RF transceiver is another one or more RF transceivers which can receive the data transmission request. For example, other RF transceiver(s) or data receiver(s) within the signal coverage of the first RF transceiver can be the second RF transceiver. There may be multiple returned data transmission responses, and since the first RF transceiver handles each data transmission response through the same operation, the description in the present embodiment is given only in respect of handling one data transmission response. The so-called local ID of the second RF transceiver is an ID that can uniquely identify the second RF transceiver, and each RF transceiver has a set local ID.

Step 220: the first RF transceiver analyzes and obtains the object ID from the data transmission response;

Step 230: the first RF transceiver judges whether the second RF transceiver returning the data transmission response is the data receiver according to the local ID and object ID; if so, step 240 will be executed, or else the second RF transceiver can be ignored;

In said step 230, the first RF transceiver can judge the relationship between itself and the second RF transceiver according to the local ID and object ID, so as to determine whether the second RF transceiver is the proper direction of data transmission, i.e. to search for the proper direction for routing to the data receiver among one or more other RF transceiver(s). When the second RF transceiver is determined as the data receiver, the second RF transceiver can be the data receiver per se, or be an RF transceiver that can be connected to the data receiver. If all the second RF transceivers returning the responses are not the data receiver, the local RF transceiver can be deemed as the data receiver by default.

Step 240: the first RF transceiver sends data to the second RF transceiver;

In said step 240, once the first RF transceiver determines the direction of sending data, it can send the data to the determined second RF transceiver in a way of directional sending. The directional sending of the RF transceiver can be realized in multiple ways, such as using the directional antennae to send toward the set direction, or controlling the data to be received only by the set object receiver through programming in a way of filtering software. For example, filtering direction-finding is conducted by using ID or user name of the object receiver.

Step 250: the second RF transceiver performs the above operations of the first RF transceiver repeatedly, i.e., the second RF transceiver performs said steps 210 to 240 being as the first RF transceiver after receiving the data, until the local transceiver is determined to be the data receiver according to the local ID, and then the data transmission stops.

In said step 250, each second RF transceiver which receives data changes to act as the first RF transceiver to continue transmitting the data. If the data has been transmitted to the data receiver, the data receiver can acknowledge that it is the transmission terminal according to only the local ID or other set parameters, such that the data transmission stops. Or, the data receiver can also perform the operations of the first RF transceiver. When searching for the next second RF transceiver, no second RF transceiver conforming to the requirements can be found according to the local ID and the object ID in the returned data transmission response, namely, the local RF transceiver is the data receiver, such that the data transmission stops.

The technical solution of the present embodiment realizes the data transmission, and this data transmission method has particularly prominent advantage for low-cost data transmission within a large-distance range. The signal receipt and transmission range of the RF transceiver is narrow, only up to several kilometers in common. However, the RF transceiver is low cost and low power consumption, so that it has cost advantage for widely arrangement in a large range. In the present embodiment, the data can be transmitted to specific upstream object device by using multiple RF transceivers in level-by-level and directional point-to-point way, such that the data can be transmitted to a designated data receiver under the large-range and long-distance conditions, and thus the long-distance data transmission at a low cost can be realized.

In the technical solution of the present embodiment, the first RF transceiver judges whether the second RF transceiver returning the data transmission response is the data receiver according to the local ID and the object ID, which preferably executes the following step:

The first RF transceiver compares whether the local ID is smaller than the object ID; if so, the second RF transceiver returning the data transmission response is determined as the data receiver; if not, the local RF transceiver is determined as the data receiver.

The direction of data transmission is determined depending on whether the ID is smaller or bigger in said technical solution, as such, all multiple RF transceivers can transmit the data to the data receiver as long as the local ID of the data receiver is set as maximum.

In practical application, many other ways can be adopted to determine the direction of the data receiver, for example, comparing whether the local ID is bigger than the object ID; if so, the second RF transceiver is determined to be the data receiver; or inquiring whether the object ID is the upstream ID of the local ID according to a index table to determine whether the second RF transceiver is the data receiver; or furthermore, determining whether the second RF transceiver is the data receiver according to a set function calculation formula.

Based on the above technical solutions, preferably the data transmission response also includes a group ID. Then, before analyzing and obtaining the object ID from said data transmission response, the first RF transceiver also analyzes and obtains the group ID, and judges whether the analyzed group ID is a local group ID; if so, it continues to perform the following operations, if not, it abandons the data transmission response.

In the above technical solution, the range of level-by-level data transmission by RF transceiver is restricted by the group ID, so as to avoid mutual interference with the data transmission by RF transceivers in other groups. With this technical solution, the RF transceivers in multiple groups can achieve multiple data transmission paths in same transmission range.

The formats of data transmission request and data transmission response will be described with examples. In the case that the group ID is set, the format of the data transmission request broadcasted by the first RF transceiver can be “this is Reader xxx, group ID AA001”, wherein “xxx” is the user name of the RF transceiver, “AA” is the group ID, and “001” is the local ID of the first RF transceiver. The format of the data transmission response returned by the second RF transceiver can be “ack to reader xxx, I am relay YYY, group ID AA003”, wherein “YYY” is the user name of the second RF transceiver, “AA” is the group ID, and “003” is the local ID of the second RF transceiver. It can be seen that these two RF transceivers belong to the same group “AA”.

### Embodiment 2

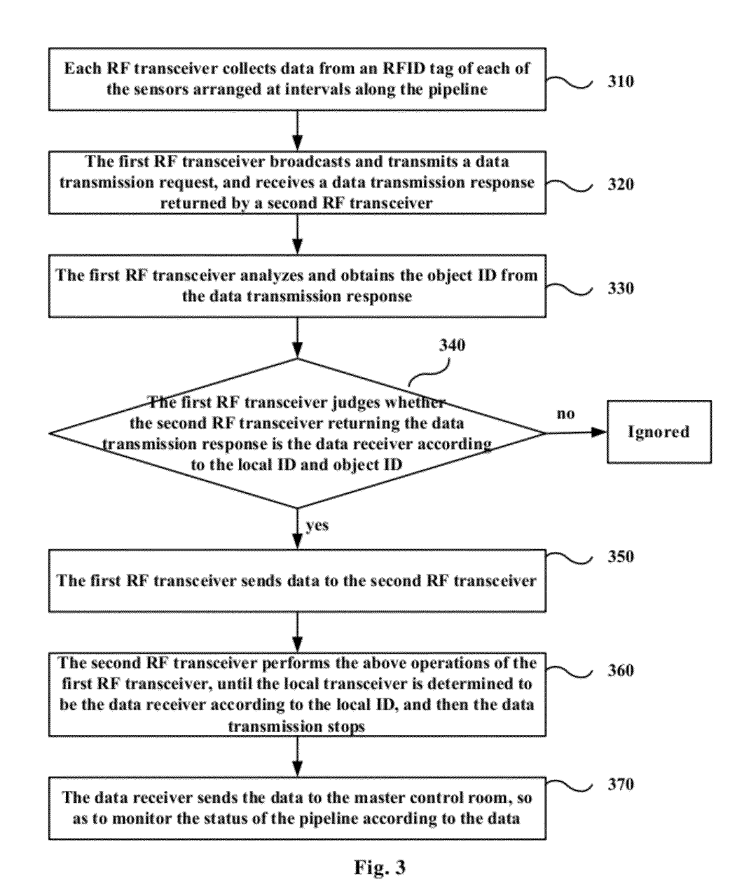

FIG. 3 is a flow chart of a pipeline monitoring method provided by the second embodiment of the present invention, which is applicable to the pipeline monitoring, particularly the pipelines arranged in a tremendous range for a long-distance transmission, such as pipelines for transferring oil, natural gas. Similar to the data transmission method provided by the present invention, the method in the present embodiment is realized by the RF transceiver. Specifically, multiple RF transceivers can be set section-by-section nearby the pipeline. The RF transceivers can transmit the data obtained from the pipeline monitoring by a sensor to a master control room over long distance so as to realize the pipeline monitoring.

The method of the present embodiment includes the following steps:

Step 310: each RF transceiver collects data from an RFID tag of each of the sensors arranged at intervals along the pipeline;

In said step 310, preferably the RFID tag is set at the sensor and the detection data collected from the pipeline by the sensor are stored in the RFID tag. The RF transceiver functions as an RFID reader for reading data from the RFID tag. Before each RF transceiver collects data from the RFID tag of each of the sensors arranged at intervals along the pipeline, the RFID tag receives the detection parameters provided by the connected sensor as the data.

Each RF transceiver, being as the first RF transceiver, can use the data transmission method provided in the embodiment of the present invention to send the data to the data receiver; specifically perform the following operations:

Step 320: the first RF transceiver broadcasts and transmits a data transmission request, and receives a data transmission response returned by a second RF transceiver, wherein the data transmission response includes at least a local ID of the second RF transceiver as an object ID;

Step 330: the first RF transceiver analyzes and obtains the object ID from the data transmission response;

Step 340: the first RF transceiver judges whether the second RF transceiver returning the data transmission response is the data receiver according to the local ID and object ID, if so, step 350 will be executed, or else the second RF transceiver can be ignored;

Step 350: the first RF transceiver sends data to the second RF transceiver;

Step 360: the second RF transceiver, being as the first RF transceiver, performs the above operations of the first RF transceiver, until the local transceiver is determined to be the data receiver according to the local ID, and then the data transmission stops;

Step 370: the data receiver sends the data to the master control room, so as to monitor the status of the pipeline according to the data.

The data receiver can be a device arranged at the specific location such as RTU, and can communicate with the master control room through cellular network, satellite or radio frequency unit (RFU).

The technical solution of the present embodiment uses low-cost RF receipt and transmission technology to realize the data transmission, and solves the problem of RF receipt and transmission distance limit in a way of point-to-point directional transmission, so as to realize the directional, point-to-point and level-by-level RF data transmission over long distance. Sensors, RFID tags and RF receivers can be arranged in a large range along the pipeline, thereby nearly full-process monitoring of the pipeline can be realized in the large range so as to improve the reliability of the pipeline transfer.

### Embodiment 3

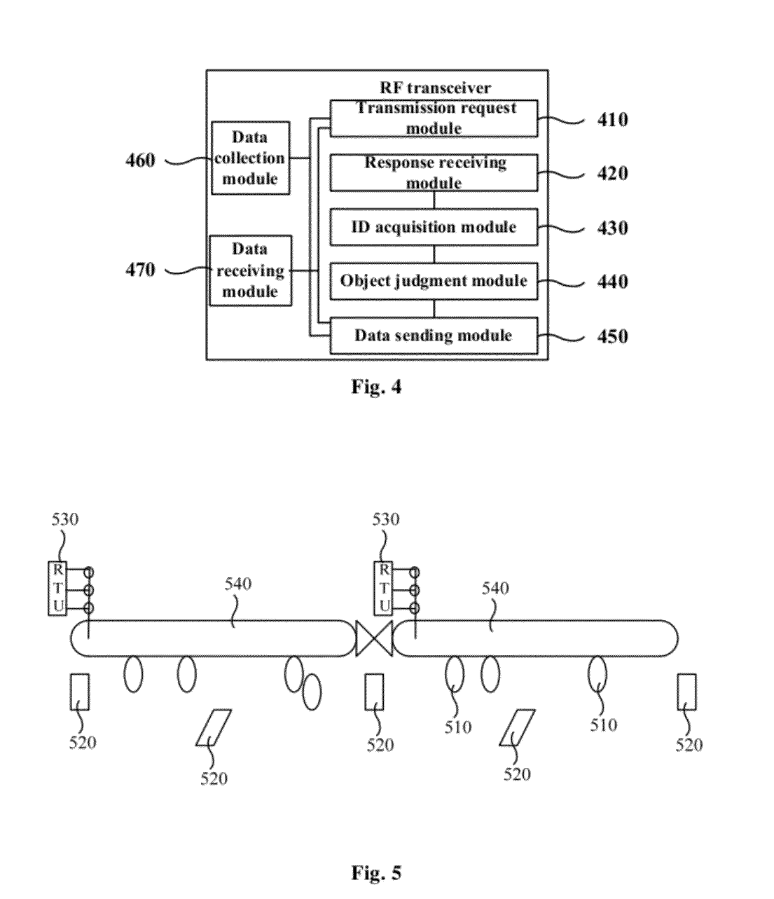

FIG. 4 is a structural diagram of an RF transceiver provided in the third embodiment of the present invention, and the RF transceiver includes a transmission request module 410, a response receiving module 420, an ID acquisition module 430, an object judgment module 440 and a data sending module 450, wherein the transmission request module 410 is adapted to broadcast and transmit a data transmission request; the response receiving module 420 is adapted to receive a data transmission response returned by a second RF transceiver, and the data transmission response includes at least a local ID of the second RF transceiver as an object ID; the ID acquisition module 430 is adapted to analyze and obtain the object ID from the data transmission response; the object judgment module 440 is adapted to judge whether the second RF transceiver returning the data transmission response is a data receiver according to the local ID and the object ID; and the data sending module 450 is adapted to send data to the second RF transceiver when the second RF transceiver returning the data transmission response is determined to be the data receiver.

The RF transceiver of the present embodiment is provided with the corresponding function modules to perform the data transmission method of the present invention as the first RF transceiver, thereby the second RF receiver which can transmit data to the data receiver can be searched and determined from multiple RF transceivers in a large range, so as to realize the level-by-level and point-to-point data transmission.

Based on the above technical solution, the RF transceiver preferably further includes a data collection module 460 and/or a data receiving module 470, wherein the data collection module 460 is adapted to collect data from an RFID tag based on an RF mode, and it is connected with the transmission request module 410 and the data sending module 450 respectively; and the data receiving module 470 is adapted to return the data transmission response including at least the local ID as the object ID when receiving the data transmission request, then receives data, and the data receiving module 470 is also connected with the transmission request module 410 and the data sending module 450 respectively.

When only the data collection module is included, the RF transceiver can be used as an RFID reader for data collection, and sends data to the second RF transceiver.

When only the data receiving module is included, the RF transceiver can also be called as RF repeater, with both functions of the first RF transceiver and the second RF transceiver, for the data transmission between two RF transceivers relatively far apart. The data received by the RF repeater may be collected by multiple data readers, and thus the RF repeater preferably has relatively large storage capacity, which may be 5 to 10 times larger than that of the common RFID reader. The signal transmission range of the RF repeater can be set according to the requirements, such as from 500 meters to several kilometers. The RF repeater and the RFID reader can be different RF transceivers, and the RFID reader is mainly in charge of data collection, possibly needs to send a control command to the RFID tag and execute anti-collision strategy, then transmits the data to back end, i.e., the RF repeater or the data receiver. The RF repeater is mainly used to relay data to realize the point-to-point wireless data transmission between RFID readers, and also can be provided with the functions of data storage and data upload.

When provided with both the data collection module and the data receiving module, the RF transceiver is simultaneously provided with the functions of RFID reader and RF repeater.

### Embodiment 4

The fourth embodiment of the present invention can be based on the third embodiment, with the difference in that the RF transceiver further includes a solar cell and a solar panel. The solar cell generates electricity through the solar panel to provide the power supply to each RF transceiver. Thereby, the RF transceiver troubled with power supply set up in the field can have a long-term and low-cost continuous power supply.

The solar panel preferably is circumferentially arranged to form a housing to cover the outside of the RF transceiver, such that it can not only protect the RF transceiver against the damage from outside natural environment, but also obtain a relatively large lighted area with a relatively small volume. The lighted area of the solar panel can be set according to the requirement for power supply, for example, an additional solar panel is connected outside the housing of the RF transceiver.

### Embodiment 5

FIG. 5 is a structural scheme diagram of a pipeline monitoring system provided by the fifth embodiment of the present invention. The pipeline monitoring system includes multiple RFID tags 510, multiple RF transceivers 520 provided by any embodiments of the present invention and a data receiver 530, wherein, the multiple RFID tags 510 are arranged at intervals along the pipeline 540 and connected with the sensors, for acquiring detection parameters of the sensors as data; the multiple RF transceiver 520 are arranged at intervals along the pipeline 540, for transmitting the data to the data receiver 530; the data receiver 530 is adapted to send the data to the master control room when receiving the data sent by the RF transceivers 520, so as to monitor the status of the pipeline 540 according to the data.

The RFID tags can be integrated inside the sensors to acquire the data collected by the sensor; for example, it can be integrated inside the sensors detecting the pipeline flow. The RFID tags can also be connected with the sensors to collect data; for example, it is connected with the sensors which collect data such as flow, temperature or pressure. The data collected by the sensors can be directly stored in the RFID tags, and then transmitted to the RFID readers intermittently according to the preset program.

In the technical solution of the present embodiment, the sensors, RFID tags and RF transceivers constitute the wireless network for monitoring the pipeline, which can monitor the transfer pipeline for oil, natural gas, chemical drugs or water and the like to ensure its reliable operation. For enabling the achievement of long-distance wireless data transmission at a low cost, the above technical solution is suitable for the arrangement in a large range. For example, the RF transceivers can be arranged at every several kilometers. The pipeline even can be monitored in full process, thereby the problem of pipeline monitoring only at some specific sites in the existing technology is solved. The sensors can transmit the data through RFID tags and RF transceivers instead of arranging nearby the specific sites, so as to eliminate the limit to the arrangement location of the sensors.

Those of ordinary skill in the art may understand that, all or a portion of the steps in the above method embodiments may be implemented by instructing relevant hardware via a program. The program may be stored in a computer-readable storage medium. Once the program is executed, the steps of the above method embodiments are accordingly performed. The above storage medium includes any medium capable of storing program codes such as a ROM, a RAM, a magnetic disk, or an optical disk.

Finally, it should be noted that the above embodiments are merely provided for describing the technical solutions of the present invention, but not intended to limit the present invention. It should be understood by those of ordinary skill in the art that although the present invention is described in detail with reference to the foregoing embodiments, modifications can be made to the technical solutions described in the foregoing embodiments, or equivalent replacements can be made to some technical features in the technical solutions, without the essence of corresponding technical solutions departing from the spirit and scope of the embodiments of the present invention.

What is claimed is:

1. A data transmission method, comprising:
broadcasting and transmitting, by a first radio frequency (RF) transceiver, a data transmission request, and receiving, by the first RF transceiver, a data transmission response returned by a second RF transceiver, wherein the data transmission response includes at least a local identification (ID) of the second RF transceiver as an object ID;
analyzing and obtaining, by the first RF transceiver, the object ID from the data transmission response;
judging, by the first RF transceiver, whether the second RF transceiver returning the data transmission response is a data receiver according to the local ID and the object ID, if so, sending data to the second RF transceiver; and
repeatedly performing, by the second RF transceiver, the above operations of the first RF transceiver, until a local RF transceiver is determined to be the data receiver according to the local ID, and then the data transmission stops.

2. The data transmission method according to claim 1, wherein the judging, by the first RF transceiver, whether the second RF transceiver returning the data transmission response is a data receiver according to the local ID and the object ID includes:
comparing, by the first RF transceiver, whether the local ID is smaller than the object ID, if so, the second RF transceiver returning the data transmission response is determined as the data receiver, if not, the local RF transceiver is determined as the data receiver.

3. The data transmission method according to claim 1, wherein the data transmission response further includes a group ID, and before the analyzing and obtaining, by the first RF transceiver, the object ID from the data transmission response, the method further includes:
analyzing and obtaining, by the first RF transceiver, the group ID, and judging, by the first RF transceiver, whether the analyzed group ID is a local group ID, if so, continuing to perform the following operations, if not, abandoning the data transmission response.

4. A pipeline monitoring method, comprising:
collecting, by each of RF transceivers, data from an RFID tag of each of sensors arranged at intervals along the pipeline;
sending, by each of the RF transceivers as a first RF transceiver, the data to a data receiver through the data transmission method according to claim 1; and
sending, by the data receiver, the data to a master control room to monitor a status of the pipeline according to the data.

5. The pipeline monitoring method according to claim 4, wherein before collecting, by each RF transceiver, data from the RFID tag of each of sensors arranged at intervals along the pipeline, the method further includes:
receiving, by the RFID tag, detection parameters provided by the connected sensor as the data.

6. A pipeline monitoring method, comprising:
collecting, by each of RF transceivers, data from an RFID tag of each of sensors arranged at intervals along the pipeline;
sending, by each of the RF transceivers as a first RF transceiver, the data to a data receiver through the data transmission method according to claim 2; and
sending, by the data receiver, the data to a master control room to monitor a status of the pipeline according to the data.

7. The pipeline monitoring method according to claim 6, wherein before collecting, by each RF transceiver, data from the RFID tag of each of sensors arranged at intervals along the pipeline, the method further includes:
receiving, by the RFID tag, detection parameters provided by the connected sensor as the data.

8. A pipeline monitoring method, comprising:
collecting, by each of RF transceivers, data from an RFID tag of each of sensors arranged at intervals along the pipeline;
sending, by each of the RF transceivers as a first RF transceiver, the data to a data receiver through the data transmission method according to claim 3; and
sending, by the data receiver, the data to a master control room to monitor a status of the pipeline according to the data.

9. The pipeline monitoring method according to claim 8, wherein before collecting, by each RF transceiver, data from the RFID tag of each of sensors arranged at intervals along the pipeline, the method further includes:
receiving, by the RFID tag, detection parameters provided by the connected sensor as the data.

10. An RF transceiver, comprising:
a transmission request module, adapted to broadcast and transmit a data transmission request;
a response receiving module, adapted to receive a data transmission response returned by a second RF transceiver, wherein the data transmission response includes at least a local ID of the second RF transceiver as an object ID;
an ID acquisition module, adapted to analyze and obtain the object ID from the data transmission response;
an object judgment module, adapted to judge whether the second RF transceiver returning the data transmission response is a data receiver according to the local ID and the object ID; and
a data sending module, adapted to send data to the second RF transceiver when the second RF transceiver returning the data transmission response is determined to be the data receiver.

11. The RF transceiver according to claim 10, further comprising:
a data collection module, adapted to collect data from an RFID tag based on an RF mode; and/or
a data receiving module, adapted to return the data transmission response when receiving the data transmission request, wherein the data transmission response includes at least the local ID as the object ID, and then receive data.

12. The RF transceiver according to claim 10, further comprising a solar cell and a solar panel, wherein the solar cell generates electricity through the solar panel, and the solar cell is used to provide power supply to each RF transceiver.

13. The RF transceiver according to claim 11, further comprising a solar cell and a solar panel, wherein the solar cell generates electricity through the solar panel, and the solar cell is used to provide power supply to each RF transceiver.

14. The RF transceiver according to claim 12, wherein the solar panel is circumferentially arranged to form a housing to cover the outside of the RF transceiver.

15. The RF transceiver according to claim 13, wherein the solar panel is circumferentially arranged to form a housing to cover the outside of the RF transceiver.

16. A pipeline monitoring system, comprising:
multiple RFID tags, arranged at intervals along the pipeline and connected with sensors, for acquiring detection parameters of the sensors as data;
multiple RF transceivers according to claim 10, arranged at intervals along the pipeline, for transmitting the data to the data receiver; and
the data receiver, adapted to send the data to a master control room when receiving the data sent by the RF transceivers, to monitor a status of the pipeline according to the data.

17. A pipeline monitoring system, comprising:
multiple RFID tags, arranged at intervals along the pipeline and connected with sensors, for acquiring detection parameters of the sensors as data;
multiple RF transceivers according to claim 11, arranged at intervals along the pipeline, for transmitting the data to the data receiver; and
the data receiver, adapted to send the data to a master control room when receiving the data sent by the RF transceivers, to monitor a status of the pipeline according to the data.

18. A pipeline monitoring system, comprising:
multiple RFID tags, arranged at intervals along the pipeline and connected with sensors, for acquiring detection parameters of the sensors as data;
multiple RF transceivers according to claim 12, arranged at intervals along the pipeline, for transmitting the data to the data receiver; and
the data receiver, adapted to send the data to a master control room when receiving the data sent by the RF transceivers, to monitor a status of the pipeline according to the data.

19. A pipeline monitoring system, comprising:
multiple RFID tags, arranged at intervals along the pipeline and connected with sensors, for acquiring detection parameters of the sensors as data;
multiple RF transceivers according to claim 13, arranged at intervals along the pipeline, for transmitting the data to the data receiver; and
the data receiver, adapted to send the data to a master control room when receiving the data sent by the RF transceivers, to monitor a status of the pipeline according to the data.

20. A pipeline monitoring system, comprising:
multiple RFID tags, arranged at intervals along the pipeline and connected with sensors, for acquiring detection parameters of the sensors as data;
multiple RF transceivers according to claim 14, arranged at intervals along the pipeline, for transmitting the data to the data receiver; and
the data receiver, adapted to send the data to a master control room when receiving the data sent by the RF transceivers, to monitor a status of the pipeline according to the data.

21. A pipeline monitoring system, comprising:
multiple RFID tags, arranged at intervals along the pipeline and connected with sensors, for acquiring detection parameters of the sensors as data;
multiple RF transceivers according to claim 15, arranged at intervals along the pipeline, for transmitting the data to the data receiver; and
the data receiver, adapted to send the data to a master control room when receiving the data sent by the RF transceivers, to monitor a status of the pipeline according to the data.
